(19) United States
(12) Patent Application Publication
(10) Pub. No.: US 2010/0325129 A1
(43) Pub. Date: Dec. 23, 2010

(54) DETERMINING THE GEOGRAPHIC SCOPE OF WEB RESOURCES USING USER CLICK DATA

(76) Inventors: Rajat Ahuja, San Jose, CA (US); Shanmugasundaram Ravikumar, Santa Clara, CA (US); Tamas Sarlos, Sunnyvale, CA (US); Dungjit Shiowattana, Belmont, CA (US); Ching--Fong Su, Milpitas, CA (US); Belle Tseng, Cupertino, CA (US); Srinivas Vadrevu, Milpitas, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/488,134

(22) Filed: Jun. 19, 2009

(51) Int. Cl. G06F 17/30

(52) U.S. Cl. 707/759; 707/769; 707/705; 707/736

(57) ABSTRACT

A geographic region is automatically determined for an Internet resource based on information that has been gathered over time through the automatic monitoring of certain “click” activities of Internet search engine-using users. Over time, the search engine collects information for each click. Using this click-related data, the search engine estimates the geographic region with which the resource ought to be associated. The fact that a significant proportion of clicks on a resource's hyperlink are clicks that “came through” a search engine portal that is associated with a geographic region tends to suggest that the resource ought to be associated with that geographic region. Similarly, the fact that a significant proportion of clicks on a resource's hyperlink are clicks that were made by users whose computers have IP addresses that are associated with a geographic region tends to suggest that the resource ought to be associated with that geographic region.

### FIELD OF THE INVENTION

The present invention relates to techniques for automatically associating a geographical region with a web site, web document, or other resource.

### BACKGROUND

Internet search engines allow computer users to use their Internet browsers (e.g., Mozilla Firefox) to submit search query terms to those search engines by entering those query terms into a search field (also called a “search box”). After receiving query terms from a user, an Internet search engine determines a set of Internet-accessible resources that are pertinent to the query terms, and returns, to the user's browser, as a set of search results, a list of the resources most pertinent to the query terms, usually ranked by query term relevance.

These resources are often individual web pages or web sites. Each search result item in a list of search result items may specify a title of a web page or web site, an abstract for that web page or web site, and a hyperlink which, when selected or clicked by the user, causes the user's browser to request the web page (or a web page from the web site) over the Internet.

Unfortunately, even through the list of search result items might contain many search result items that actually are relevant to the query terms, in that the web pages or web sites to which those search result items refer actually do contain instances of those query terms, the search result items still all might relate to place and cultures that are not of any interest at all to the user who submitted the query terms. For example, a user in India might submit, to a search engine, query terms that indicate that the user is looking for a particular kind of store. Under such circumstances, it is likely that the user is looking for a particular kind of that store that has locations in India. The search engine might not be aware of this fact, though. As a result, the list of search results to that search engine returns to the user might be dominated by search result items that pertain to the particular kind of store whose locations are only in the United States of America. This might be due largely to the fact that stores and other businesses in the United States of America have tended to establish prominent on-line presences. The user in India is likely to be frustrated by the list of search results that he receives.

One hypothetical way in which search results might be improved could be by having a team of human editors examine every web page in a search engine's index and subjectively determine, based on the internal contents of those web pages, the locations with which those web pages probably ought to be associated. However, the quantity of web pages in the search engine's index could be immense. The time and expense that such a hypothetical approach would involve would be prohibitive. Some other, more efficient and scalable way of providing location-relevant search results to a user is needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments of the present invention are illustrated by way of example, and not by way of limitation, in the figures of the accompanying drawings and in which like reference numerals refer to similar elements and in which:

FIG. 1 is a flow chart that illustrates an example of a technique that may be performed to gather, over some time frame, attribute information pertaining to each click on each hyperlink that is listed in each set of search results that a search engine provides to any user during that time frame, according to an embodiment of the invention;

FIG. 2 is a flowchart that generally describes an example technique for automatically determining a region for a web page or other entity using attribute information that a search engine has gathered, according to an embodiment of the invention; and

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to techniques described herein, a geographic region (e.g., a nation, state, continent, city, county, neighborhood, place, etc.) is automatically determined for a web site, web document, or other Internet resource. An association between that Internet resource and the automatically determined geographic region is established and stored on a computer-readable storage medium for later use. Although the discussion below focuses on the determination of geographic or geopolitical regions for web pages, the techniques discussed are also applicable to determine such regions for other entities such as web sites.

One technique described herein involves determining a geographic region for an Internet resource based on information that has been gathered over time through the automatic monitoring of certain “click” activities of a multitude of Internet search engine-using users. Each time that such a user clicks on or otherwise selects a resource-referencing hyperlink (the “resource's hyperlink”) from a list of search results provided by an Internet search engine, the search engine records at least two items of information regarding that click.

One of these items of information is the geographic location that is already associated with the Internet search engine portal through which the user submitted the query terms that caused the search engine to include the resource's hyperlink within the list of search results. A given user might have submitted the query terms through any one of a multitude of different portals that act as an interface to the search engine. Each such portal may be associated with a different geographic region. For example, one such portal having a regional Internet domain of “fr” in its uniform resource locator (“URL”) might be associated with the geographic region of “France.” As used herein, a click on a hyperlink that was included in a search result list that was returned by a search engine as a result of that search engine having received query terms through a particular portal is described as having “come through” that particular portal.

The other one of these items of information is the Internet Protocol (“IP”) address of the computer of the user that clicked on the resource's hyperlink in the list of search results. This IP address can be obtained automatically from data that is contained in the headers of IP packets, for example. Certain sets of IP addresses are known to be associated with certain geographic regions. Thus, if the user's computer's IP address belongs to such a set, then the geographic location of the user can be estimated with high confidence.

Over time, as many different users each click on the resource's hyperlink, the search engine collects and aggregates these two items of information for each click. Given a sufficiently large set of this click-related data, the search engine can confidently estimate the geographic region with which the resource ought to be associated. The fact that a statistically significant proportion of clicks on a resource's hyperlink are clicks that “came through” a search engine portal that is associated with a particular geographic region tends to suggest that the resource ought to be associated with that particular geographic region. Similarly, the fact that a statistically significant proportion of clicks on a resource's hyperlink are clicks that were made by users whose computers have IP addresses that are associated with a particular geographic region tends to suggest that the resource ought to be associated with that particular geographic region. Essentially, the fact that interest in a resource seems to come dominantly from a particular geographic region, as evidenced by the aggregated click data discussed above, tends to suggest that the resource is related to that particular geographic region.

Collecting Regional Attributes of Search Result Item Selections

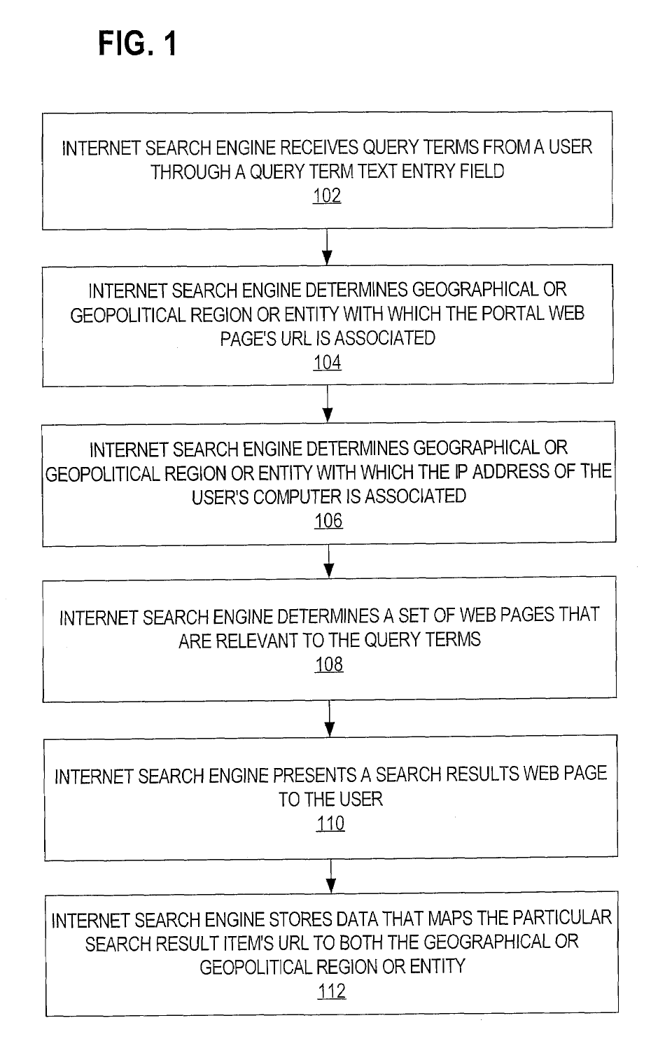

As is discussed above, in one embodiment of the invention, an Internet search engine gathers, over some time frame, attribute information pertaining to each click on each hyperlink that is listed in each set of search results that the search engine provides to any user during that time frame. FIG. 1 is a flow chart that illustrates an example of a technique that the Internet search engine might perform in order to gather this attribute information, according to an embodiment of the invention. The technique described with reference to FIG. 1 relates to the operations that the search engine might perform relative to a single one of a multitude of search engine users, but it should be understood that the search engine may perform the technique many times relative to many different users over time.

In block 102, the Internet search engine receives query terms from a user through a query term text entry field that is displayed in a portal web page. The portal web page (displayed to the user through the user's Internet browser) has a URL. For example, the portal web page might have a URL such as “fr.yahoo.com” (or “www.yahoo.fr”) if the portal page is French, or “de.yahoo.com” (or “www.yahoo.de”) if the portal page is German. The Internet search engine is capable of receiving query terms through any of several different portal web pages, each of which may be associated with a different geographical or geopolitical URL.

In block 104, the Internet search engine determines a geographical or geopolitical region or entity with which the portal web page's URL is associated. For example, if the portal page's URL is “fr.yahoo.com,” then the search engine may determine that the portal page's URL is associated with the region “France.” For another example, if the portal page's URL is “de.yahoo.com,” then the search engine may determine that the portal page's URL is associated with the region “Germany.” In one embodiment of the invention, the search engine makes the determination by consulting a table that maps different URLs (or portions thereof) to different specified regions and finding, in the table, a mapping between the portal's URL (or a portion thereof) and a corresponding region.

In block 106, the Internet search engine determines a geographical or geopolitical region or entity with which the IP address of the user's computer is associated. In one embodiment of the invention, the search engine gleans the user's computer's IP address from a field in a packet header that the search engine received from the user's computer when the search engine received the query terms. In one embodiment of the invention, the search engine makes the determination by consulting a table that maps different ranges or sets of IP addresses (or portions thereof) to different specified regions and finding, in the table, a mapping between an address range or address set into which the user's computer's IP address (or a portion thereof) belongs and a corresponding region.

In block 108, the Internet search engine determines a set of web pages that are relevant to the query terms. For example, for each query term received from the user in block 102, the search engine may locate that query term in a previously constructed index of terms, and determine a set of web pages that are mapped to that query term in the index—these typically will be all of the web pages that are known to contain at least one instance of that query term. The index may be populated by an automated web crawler that continuously follows hyperlinks between web pages on the Internet and creates appropriate mappings in the index based on the contents of each web page that the web crawler visits. After a set of web pages has been determined for each query term in the set of query terms received from the user, the search engine may generate a final set of web pages for the whole query by determining the intersection of all of the query terms' web page sets. The search engine may rank the web pages based on relevance to the query terms using a specified ranking algorithm.

In block 110, the Internet search engine presents a search results web page to the user. The search results web page contains one or more search result items. Each search result item is from the set of query-relevant web pages that the search engine determined in block 108. The search result web page may contain the search result items that correspond to the top “N” most query-relevant web pages that were determined in block 108. In one embodiment of the invention, each search result item includes at least a title of that search result item's corresponding web page, an abstract of that search result item's corresponding web page, and a hyperlink to that search result item's corresponding web page. The text of the hyperlink may show the search result item's URL. A user's selection or activation of a particular search result item's hyperlink (e.g., by the user clicking on that hyperlink) causes the user's Internet browser to load and present the web page at the URL to which that hyperlink refers.

In block 112, in response to the user's selection or activation of a particular search result item's hyperlink in the search results web page, the Internet search engine stores data that maps the particular search result item's URL (or other unique identifier of the web page to which the particular search result item corresponds) to both (a) the geographical or geopolitical region or entity that was determined in block 104 (i.e., the region or entity to which the portal is mapped) and (b) the geographical or geopolitical region or entity that was determined in block 106 (i.e., the region or entity to which the IP address is mapped). The Internet search engine may store this information on any computer-readable medium, such as a hard disk drive or other magnetic storage media. As time passes and multiple users click on the particular search result item, perhaps after submitting many different query terms through many different portals, the quantity of data associated with the particular search result item's URL or other identifier will increase.

Although the technique described above refers specifically to an embodiment of the invention in which portal regional attributes and IP address regional attributes are collected, alternative embodiments of the invention may involve the collection of additional or alternative regional attributes. The discussion of regional attributes associated with a portal web page and with an IP address should not be construed as limiting embodiments of the invention to techniques that only take into account those indications of a web page's geographical location. Other kinds of attributes may be collected and used, in addition to or instead of the attributes specifically mention above, in order to aid in the determination of a web page or other entity's affinity to a geographical location.

For example, other information that may be taken into account when determining attributes for a web page may include a self-specified geographical location of a user that activated the hyperlink that refers to the web page. Such a geographical location may be specified by the user in the user's profile for an online social networking community, for example. Users that have specified an affiliation with a particular geographical region might be more likely to be interested in web pages that are also affiliated with that region, and such users' selections of search result item hyperlinks are indicative that the web pages to which those hyperlinks refer are more likely to be affiliated with that region also.

For another example, a web page's attributes that are collected as discussed above may include the current and actual device-reported geographical location of a mobile device through which the user submitted the query terms to the Internet search engine. Such a geographical location may comprises a latitude value and a longitude value determined by a global positioning system (GPS) mechanism that estimates those values based on signals received from an Earth-orbiting satellite or other broadcasting station. The geographical location attribute reported by the user's mobile device signifies the location of the mobile device's user at the time that the user submitted the query terms to the search engine. Users that submit query terms through a mobile device from a particular geographical region might be more likely to be interested in web pages that are also affiliated with that region, and such users' selections of search result item hyperlinks are indicative that the web pages to which those hyperlinks refer are more likely to be affiliated with that region also.

Determining Region Based on Collected Features

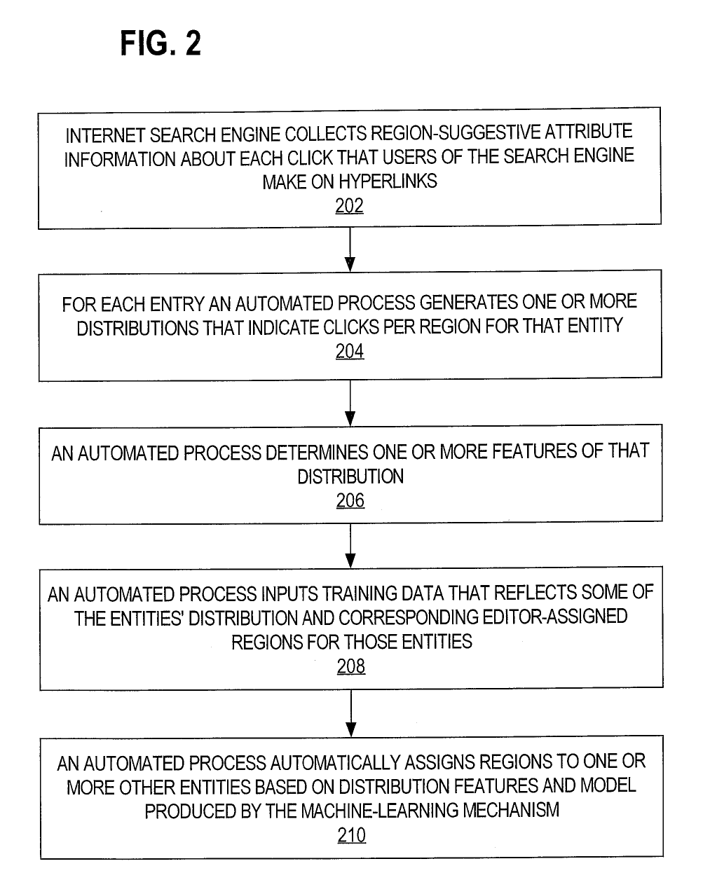

FIG. 2 is a flowchart that generally describes an example technique for automatically determining a region for a web page or other entity using attribute information that a search engine has gathered, according to an embodiment of the invention. In block 202, an Internet search engine collects region-suggestive attribute information about each click that users of the search engine make on hyperlinks that are associated with search result items that the search engine returned to those users. The Internet search engine may perform the technique described above with reference to FIG. 1 in order to collect this attribute information, for example. In block 204, for each entity (e.g., web page, web site, etc.) for which the Internet search engine collected attribute information, and based on the attribute information collected for that entity, an automated process generates one or more distributions that indicate clicks per region for that entity. In block 206, for each distribution generated in block 204, an automated process determines one or more features of that distribution. In block 208, an automated process inputs, into a machine-learning mechanism, training data that reflects (a) features determined for at least some of the entities' distributions and (b) corresponding editor-assigned regions for those entities. As a result, the machine-learning mechanism produces a model. In block 210, an automated process automatically assigns regions to one or more other entities based on (a) the distribution features that have been determined for those other entities and (b) the model produced by the machine-learning mechanism.

Specific aspects of the foregoing general technique are described by way of example below.

Distributions Based on Regional Attributes

As is discussed above, in one embodiment of the invention, a search engine collects different types of regional attributes each time that any user clicks on a hyperlink to a web page that is represented in a list of search results. In one embodiment of the invention, these attribute types include a portal regional attribute and an IP address regional attribute (although, in other embodiments of the invention, these attribute types may additionally or alternatively include other region-suggesting attribute types, some of which are discussed above). In one embodiment of the invention, after the search engine has collected several attributes of each type for a particular web page, the search engine creates two (or, in alternative embodiments of the invention, more or less than two) separate distributions for that particular web page: a portal regional distribution and an IP address regional distribution. The portal regional distribution indicates, for each region of a set of regions, the quantity of user selections of the particular web page's search result item that came through a portal associated with that region. The IP address regional distribution indicates, for each region of the set of regions, the quantity of user selections of the particular web page's search result item that came from an IP address that is associated with that region. Thus, the search engine may create a separate pair of distributions (portal regional and IP address regional) for each web page in a search corpus.

As is mentioned above, some embodiments of the invention may take into account region-suggesting attributes other than portal regional attributes and IP address regional attributes. In such embodiments of the invention, separate distributions may be generated for those other region-suggesting attributes as well.

### Distribution Features

In one embodiment of the invention, after the two (or, alternatively, other number of) types of distributions have been created for a particular web page, the search engine or some other automated process determines multiple different features of each of the particular web page's distributions. One of these features is called “spread.” In one embodiment of the invention, the spread is the minimum number of regions, in a distribution, that are required to cover a specified percentage of the clicks on the web page to which that distribution corresponds. In one embodiment of the invention, the specified percentage is 90%, although, in alternative embodiments of the invention, the specified percentage may be more or less than 90%. For example, if a minimum of three regions were required to cover at least 90% of the clicks in a distribution, then, in one embodiment of the invention, the spread for that distribution would be three. Distributions in which relatively few regions contain the majority of clicks for that distribution are likely to have lower spreads than distributions in which the clicks for that distribution occur in approximately the same quantities in most of the regions.

In one embodiment of the invention, an automated process determines the minimum number of regions required to cover the specified percentage of clicks by adding, to a set of regions that begins as the empty set, the distribution's region that covers the greatest number of the distribution's total clicks. Then, if the percentage of the distribution's total clicks covered by all of the regions in that set is still less than the specified percentage, the process adds, to the set of regions, the distribution's region that covers the next greatest number of the distribution's clicks. This process continues until all either all of the distribution's regions have been added to the set of regions, or until the percentage of the distribution's total clicks covered by all of the regions in the set of regions is not less than the specified percentage. Then, the distribution's spread is determined to be the number of regions in the set of regions to which the regions were added, one-at-a-time, in this manner.

Another of the features is called “entropy.” In one embodiment of the invention, an automated process begins to compute a distribution's entropy by calculating a probability for each region in the distribution, where that region's probability is the percentage or proportion of that distribution's clicks that are contained by that region. Then, the process computes the result of the formula:

$$- {\sum }_{i = 1}^{n} {p}_{i} log {p}_{i}$$

where n is the number of regions in the distribution, and pᵢ is the probability calculated for region i in the distribution. The value resulting from this formula is the distribution's entropy. A distribution that has clicks from a relatively high number of different regions will have greater entropy, and thus less confidence in indicating a region for a web page, than a distribution that has clicks from a relatively low number of different regions. Entropy of zero is indicative that all of the distribution's clicks belong to a single region.

Another of the features is called “region likelihood.” A region likelihood is determined for the region, in a particular distribution, that covers the greatest number of the distribution's clicks of any of that distribution's regions. In one embodiment of the invention, the region likelihood for a particular region is the number of clicks for that region alone divided by the total number of clicks across all regions in the distribution. Thus, if a particular region in a web page's distribution represented 10,000 clicks, and if the total number of clicks recorded for that web page was 1,000,000, then the regional likelihood for that particular region, in that distribution, would be 0.01, or 1%. In one embodiment of the invention, the region likelihood is determined as a ratio (with the total number of clicks for a web page across all regions as a denominator), rather than a raw quantity of clicks pertaining to the particular region, in order to normalize region likelihoods between distributions for different web pages (since some web pages' search result item hyperlinks may receive many more clicks than other web pages' search result item hyperlinks). It should be understood that other techniques for normalizing regional likelihoods across distributions may, additionally or alternatively, be used.

Normalization between different web pages' distributions may be desirable because some search result item hyperlinks that refer to popular web pages may receive a much higher quantity of clicks than do other search result item hyperlinks that refer to more obscure web pages. In one embodiment of the invention, all of the distributions of a particular attribute type are normalized relative to each other. In one such embodiment of the invention, this cross-distribution normalization is performed using the Laplace smoothing method. As a result of the smoothing method, different web pages' distributions of a particular type are equalized in magnitude (so as to correspond to a similar scale as each other) while still reflecting the previously existing relative differential proportions in magnitude between the regions' measurements within a particular distribution. In various different embodiments of the invention, the features described herein may be determined from distributions on which smoothing has been performed, and/or from distributions on which smoothing has not been performed.

Thus, in one embodiment of the invention, for each web page, a distribution feature set for that web page is automatically determined in the manner described above. The set of distribution features for a particular web page may include both (a) a set of features determined based on the web page's portal attribute distribution and (b) a set of features determined based on the web page's IP address attribute distribution. In embodiments of the invention in which additional or alternative regional features have been associated with web pages, the set of distribution features may additionally or alternatively include attribute distributions for those features too.

Machine-Learned Distribution Feature Set-to-Region Mapping

As is discussed above, in one embodiment of the invention, a set of distribution features is automatically determined for a web page based on the feature distributions that are associated with that web page. In one embodiment of the invention, a mapping between a set of feature distributions and a definitive region is determined using machine-learning techniques. One of these techniques is discussed below.

In one embodiment of the invention, either before or after a set of distribution features has been determined for a particular web page, an editor examines the particular web page and makes a judgment as to which region the particular web page actually and definitively belongs. In one embodiment of the invention, the editor is a human being, but in an alternative embodiment, the editor is a custom-programmed automated process designed specifically to assign a region to a web page based some set of specified criteria. The editor may take many different specified criteria into account when making this judgment. For example, the editor may take into account the topics to which the content of the web page pertains and/or the language in which the content of the web page is composed. After making this judgment, the editor assigns a definitive region to the web page. This definitive region is the region to which the web page is deemed to actually belong, regardless of what the web page's set of distribution features might indicate.

In one embodiment of the invention, after several web pages have had both (a) a set of distribution features and (b) a definitive region determined for them and assigned to them, data that maps each web page's distribution features to that web page's definitive region is input as training data into an automated machine-learning mechanism. The machine-learning mechanism automatically determines, based on the training data, and for each definitive region that occurs in the training data, that web pages which are associated with that definitive region tend also to be associated with certain distribution features. Thus, for each definitive region that occurs in the training data, the machine-learning mechanism automatically determines a set of distribution features that tend to be shared among all web pages that have been associated with that definitive region. The correlation between (a) definitive regions and (b) sets of distribution features that tend to be shared by web pages that belong to those definitive regions essentially becomes a model, or set of rules.

In one embodiment of the invention, the machine-learning mechanism uses gradient boosted trees (GBT) to train a feature classifier. The machine-learning mechanism may, additionally or alternatively, use other techniques to train a feature classifier.

Automatic Region Assignment Based on Machine-Learned Model

Based on the machine-learned model discussed above, an automated process can estimate a definitive region for other web pages which were not a part of the training data and which have not been assigned a definitive region by an editor (human or otherwise). An automated process may compare the set of distribution features that is associated with such a web page to each of the machine-learned definitive region-to-feature set mappings that are indicated by the model. The automated process may determine which of the model's mappings contains a distribution feature set that most closely resembles an unassigned web page's distribution feature set. The automated process may then automatically assign, to the unassigned web page, the definitive region that is mapped, in the model, to the distribution feature set that most closely resembles the unassigned web page's distribution feature set. The automated process also may compute, based on the extent of similarity of the web page's distribution feature set to the distribution feature set that is mapped to the definitive region in the model, a confidence score that indicates a degree of confidence that the definitive region that has been automatically assigned to the web page is correct (i.e., the degree of confidence that the same definitive region would have been assigned to the web page if the definitive region had been assigned to the web page, instead, by the same editor that assigned definitive regions to the web pages in the training data).

Beneficially, automatically assigning definitive regions to web pages using the comparison of the web page's distribution feature to those in the machine-learned model, as discussed above, can be much faster and less expensive than other approaches for assigning definitive regions to web pages. Although an editor (human or otherwise) might initially label a relatively small quantity of web pages in the training data set with definitive regions, the amount of time and the quantity of human and/or computational resources required to perform that initial labeling might be so great that performing the same high-scrutiny labeling process relative to much larger quantities of web pages might be prohibitive. Using the machine learning technique discussed above, a lesser amount of time and a lesser quantity of resources (none of which need to be human) can be used to assign definitive regions to large quantities of web pages automatically, and with nearly the same accuracy, if not the same accuracy, as was possessed by the more time-and-resource-consuming initial labeling process performed by the editor. Using the machine learning technique discussed above, definitive regions can be automatically assigned to web pages outside of the training data without ever inspecting any of the contents of those web pages.

Types of Entities for Which Regions can be Determined

Techniques for automatically determining a geographical or geopolitical region for an individual web page are discussed above. However, in alternative embodiments of the invention, such regions are, additionally or alternatively, automatically determined for a web site (comprising multiple web pages that all belong to the same Internet domain), a specified set of web sites, a set of resources that belong to a specified network, an entire top-level Internet domain (e.g., “.gov,” “.edu,” “.mil,” “.biz,” “.org,” “.com,” etc.), and/or some other Internet-accessible resources other than a web page (e.g., a file that represents audio, motion video, a still image, or other text).

In one embodiment of the invention, the click data described above is aggregated for each web page that belongs to the entity for which a region is to be determined. For example, if the entity for which a region is to be determined is a web site, then the click data discussed above (including portal regional attributes and IP address regional attributes) for each web page that belongs to that web site can be aggregated. Based on the data aggregated for the entity, a portal regional distribution and an IP address regional distribution can be created for the entity as a whole. Based on these distributions, features of the entity can be automatically determined using the techniques described above.

Uses of Regional Information Associated with Internet Entities

Techniques are discussed above for automatically assigning regions to web pages, web sites, or other entities automatically and in a scalable manner. After a mapping between such an entity and the region that has been assigned to that entity has been stored, the regional information can be used for a variety of beneficial purposes, at least some of which are described below.

In one embodiment of the invention, in response to a user's entry of query terms through a portal web page of an Internet search engine (as is discussed above with reference to block 102 of FIG. 1), the search engine determines the geographic or geopolitical region that is mapped (e.g., in a stored table) to that portal web page. After the search engine determines the set of web pages that are relevant to the query terms (as is discussed above with reference to block 108 of FIG. 1), the search engine ranks the web pages based on those pages' relevance to the query terms. In one embodiment of the invention, when ranking the web pages, those of the web pages that are associated with the same geographical region to which the portal web page is mapped receive a promotion in their relevance scores or ranks, so that search result items referring to those pages have a greater likelihood of being presented higher in the ranked list of search results than do pages that are not associated with the same geographical region as that of the portal. Additionally or alternatively, web pages not associated with the same region as the portal web page may receive demotions in relevance score or rank.

For example, if the search engine received query terms through the text entry field of a portal web page that was associated with the “India” region, then the search engine might subsequently augment the relevance scores of all web pages that are assigned to the “India” region through techniques described above. As a result, and depending in part on the extent to which the benefited search result items' relevance scores were augmented, the user would be more likely to see term-relevant search result items that referred to India-associated web pages than term-relevant search results that referred to web pages that were not associated with India. Because the user submitted query terms through a web portal page that was associated with India, it is likely that the user was searching primarily for relevant web pages that were associated with India rather than other regions.

In another embodiment of the invention, in response to a user's selection or activation of a search result item's hyperlink, the search engine or some other automated process automatically selects, from a set of advertisements or other multimedia content items, an advertisement or other multimedia content item that is mapped to the same geographical region to which the hyperlink-referencing web page or other resource is mapped. The search engine or other process inserts the selected advertisement or multimedia content item into the referenced web page or other resource before the search engine forwards that web page or other resource to the user's Internet browser. As a result, when the user's Internet browser displays the web page or other resource, the Internet browser also displays the region-relevant advertisement or other selected multimedia content item in conjunction with the display of the web page or other resource.

For example, in one embodiment of the invention, if the user clicks on a search result item's hyperlink that refers to a web page that is associated with the “India” region, then the search engine responsively selects, from a set of available advertisements that may be mapped to various different regions, an advertisement that is mapped specifically to the “India” region. The search engine inserts, into the hyperlink-referenced web page, hypertext code (e.g., an image reference tag that specifies the selected advertisement's URL) that causes the selected advertisement to be loaded and displayed by the user's Internet browser. The search engine then sends the modified web page over the Internet to the user's browser, which loads and displays the selected advertisement, showing the advertisement at the location in the web page in which the search engine inserted the hypertext code.

In another embodiment of the invention, the automatically determined region assignments are used in order to ensure that the web crawler, which updates the search engine's index, devotes a specified proportion of time and resources to crawling web pages that have been associated with a particular region. For example, an administrator may specify, in a set of instructions that the web crawler follows, that the web crawler should attempt to spend a specified amount of time every day following links from web pages that are associated with a particular region. For another example, an administrator may specify, in the set of instructions that the web crawler follows, that the web crawler should attempt to ensure that a specified proportion of the links that the web crawler crawls during any day are hyperlinks that are contained in web pages that are associated with a particular region. The administrator may specify similar instructions for multiple regions, so that the web crawler devotes an approximately equal amount of time to discovering Internet resources for each region in a known set of regions. When the web crawler follows hyperlinks from web pages that are known to be associated with a particular region, the web pages to which those hyperlinks refer are likely to correspond to the particular region also. Thus, the web crawler may be more likely to populate the search engine's index with references to web pages that pertain to a variety of regions, thereby reducing the probability that the search engine will only return results that pertain to a single region regardless of a user's likely interest in search results from another region.

### Region Seeding

In one embodiment of the invention, unassigned web pages for which no click data has been collected (perhaps because the Internet search engine never returned a search result item that linked to those web pages, or because no user ever clicked on any search result items that linked to those web pages) are automatically assigned regions based on the regions that have been automatically assigned to other web pages that link to, or are linked to by, the unassigned web pages. For example, in one embodiment of the invention, after the techniques described above have been performed relative to a particular “seed” web page, then a set of other web pages that either (a) contain a link to the seed web page or (b) are referenced by a link that the seed web page contains is automatically determined. For each web page in this set of other web pages, if that web page has not yet been assigned any region, then an automated process automatically assigns, to that web page, the same region that has already been assigned to the seed web page. The technique can then be applied recursively, using each web page that was assigned a region in this manner as a seed web page for other unassigned web pages.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

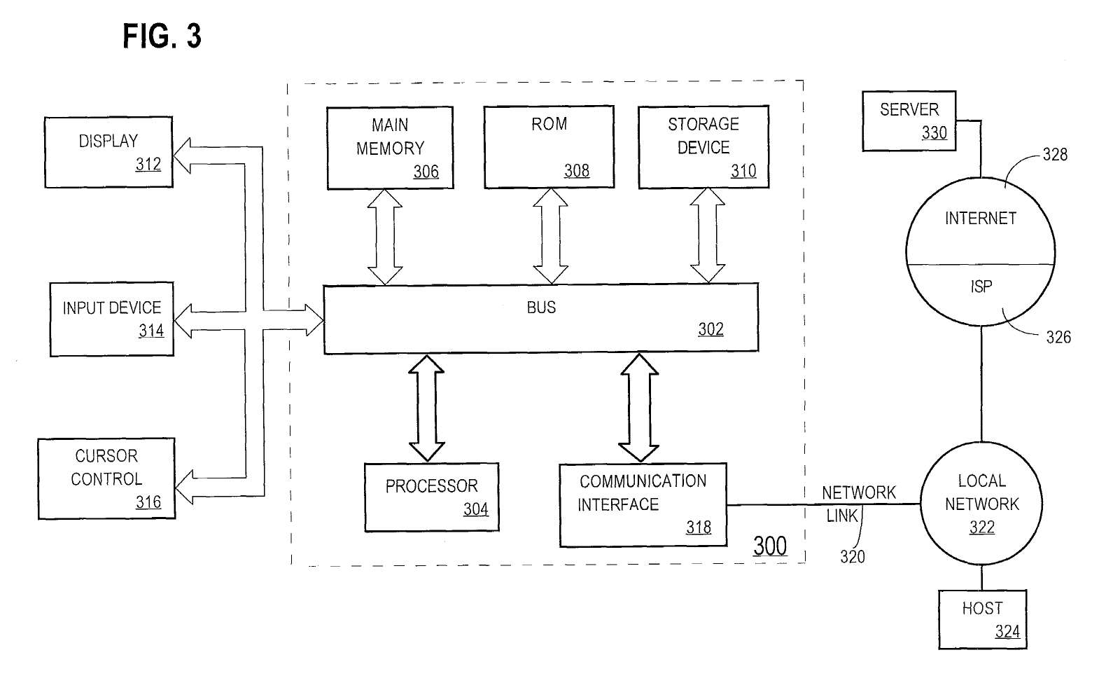

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
in response to a user's selection of a hyperlink that is associated with a particular search result item in a set of search result items that a search engine provided in response to a query, determining one or more geographical location attributes that are related to the user's selection of the hyperlink;
based at least in part on the one or more geographical location attributes, determining a geographical region for a resource to which the hyperlink refers; and
storing, on a computer-readable storage medium, data that maps the resource to the geographical region;
wherein the one or more geographical location attributes include at least one of (a) a region that is associated with a portal through which the search engine received the query, (b) a region that is associated with an address of device from which the search engine received the query, (c) a region that is self-associated with the user that selected the hyperlink, and (d) a region that is associated with geographic coordinates of a location of the device at a time that the search engine received the query;
wherein the foregoing steps are performed by a computer system.

2. The method of claim 1, further comprising:
after storing the data that maps the resource to the geographical region, receiving one or more query terms through a portal that is mapped to a particular region;
in response to receiving the one or more query terms, generating a set of search results that includes the particular search result item;
determining, based on the data that maps the resource to the geographical region, that the resource is mapped to the particular region to which the portal is mapped; and
in response to determining that the resource is mapped to the particular region to which the portal is mapped, modifying a ranking of the particular search result item in a relevance-ranked list of search result items; and
sending at least part of the relevance-ranked list to a device of a user from whom the one or more query terms were received.

3. The method of claim 1, further comprising:
after storing the data that maps the resource to the geographical region, determining that a hyperlink to the resource has been selected from a list of search results;
in response to determining that the hyperlink to the resource has been selected from the list of search results, selecting, from a set of two or more advertisements, a particular advertisement that is mapped to the geographical region to which the resource is mapped;
modifying the resource to include a reference to the particular advertisement, thereby producing a modified resource that includes the reference to the particular advertisement; and
sending the modified resource to a user that selected the hyperlink to the resource from the list of search results.

4. The method of claim 1, further comprising:
after storing the data that maps the resource to the geographical region, storing, on a computer-readable storage medium, instructions that instruct a web crawling mechanism to devote a specified quantity of resources of the web crawling mechanism to following hyperlinks from web pages that are mapped to the geographical region.

5. The method of claim 1, wherein determining the one or more geographical location attributes that are related to the user's selection of the hyperlink comprises determining at least one of the one or more geographical location attributes to be a particular geographical region that is mapped to a portal web page through which the search engine received the query.

6. The method of claim 1, wherein determining the one or more geographical location attributes that are related to the user's selection of the hyperlink comprises determining at least one of the one or more geographical location attributes to be a particular geographical region that is mapped to a group of Internet Protocol (IP) addresses that contains a particular IP address of a device from which the search engine received the query.

7. The method of claim 1, wherein determining the geographical region for the resource to which the hyperlink refers comprises determining one or more features of a distribution that indicates, for each particular region in a set of regions, a quantity of selections of the hyperlink that were associated with that particular region.

8. The method of claim 7, wherein determining the one or more features of the distribution comprises determining a minimum number of regions in the distribution that cover a specified proportion of a total number of hyperlink selections represented by the distribution, wherein determining the one or more features of the distribution comprises determining the distribution's entropy, and further comprising:
selecting, based on the one or more features of the distribution, and from among multiple distribution feature sets that a machine-learning mechanism has automatically mapped to different geographical regions, a particular distribution feature set that has one or more features in common with the one or more features of the distribution;
wherein determining the geographical region for the resource to which the hyperlink refers comprises determining the geographical region for the resource to which the hyperlink refers to be a particular geographical region to which the machine-learning mechanism mapped the particular feature distribution set.

9. The method of claim 7, wherein the resource is a first resource, wherein determining the one or more features of the distribution comprises determining a first distribution for the first resource, and further comprising:
determining a second distribution for a second resource that differs from the first resource;
normalizing the first distribution with the second distribution by performing smoothing on the first distribution and the second distribution; and
wherein determining the geographical region for the first resource comprises determining the geographical region for the first resource based at least in part on a version of the first distribution on which said smoothing has been performed.

10. A computer-implemented method comprising:
in response to a user's selection of an item, determining one or more category attributes that are related to the user's selection of the item;
based at least in part on the one or more category attributes, determining a category for the item; and
storing, on a computer-readable storage medium, data that maps the item to the category;
wherein the one or more category attributes include at least one of (a) a category that is associated with an interface through which the user selected the item, (b) a category that is associated with a device from which the user selected the item, (c) a category that is self-associated with the user that selected the item, and (d) a category that is associated with geographic coordinates of a location of the device at a time that the user selected the item;
wherein the foregoing steps are performed by a computer system.

11. A volatile or non-volatile computer-readable storage medium storing one or more instructions which, when executed by one or more processors, cause the one or more processors to perform steps comprising:
in response to a user's selection of a hyperlink that is associated with a particular search result item in a set of search result items that a search engine provided in response to a query, determining one or more geographical location attributes that are related to the user's selection of the hyperlink;
based at least in part on the one or more geographical location attributes, determining a geographical region for a resource to which the hyperlink refers; and
storing, on a computer-readable storage medium, data that maps the resource to the geographical region;
wherein the one or more geographical location attributes include at least one of (a) a region that is associated with a portal through which the search engine received the query, (b) a region that is associated with an address of device from which the search engine received the query, (c) a region that is self-associated with the user that selected the hyperlink, and (d) a region that is associated with geographic coordinates of a location of the device at a time that the search engine received the query.

12. The volatile or non-volatile computer-readable storage medium of claim 11, wherein the steps further comprise:
after storing the data that maps the resource to the geographical region, receiving one or more query terms through a portal that is mapped to a particular region;
in response to receiving the one or more query terms, generating a set of search results that includes the particular search result item;
determining, based on the data that maps the resource to the geographical region, that the resource is mapped to the particular region to which the portal is mapped; and
in response to determining that the resource is mapped to the particular region to which the portal is mapped, modifying a ranking of the particular search result item in a relevance-ranked list of search result items; and
sending at least part of the relevance-ranked list to a device of a user from whom the one or more query terms were received.

13. The volatile or non-volatile computer-readable storage medium of claim 11, wherein the steps further comprise:
after storing the data that maps the resource to the geographical region, determining that a hyperlink to the resource has been selected from a list of search results;
in response to determining that the hyperlink to the resource has been selected from the list of search results, selecting, from a set of two or more advertisements, a particular advertisement that is mapped to the geographical region to which the resource is mapped;
modifying the resource to include a reference to the particular advertisement, thereby producing a modified resource that includes the reference to the particular advertisement; and
sending the modified resource to a user that selected the hyperlink to the resource from the list of search results.

14. The volatile or non-volatile computer-readable storage medium of claim 11, wherein the steps further comprise:
after storing the data that maps the resource to the geographical region, storing, on a computer-readable storage medium, instructions that instruct a web crawling mechanism to devote a specified quantity of resources of the web crawling mechanism to following hyperlinks from web pages that are mapped to the geographical region.

15. The volatile or non-volatile computer-readable storage medium of claim 11, wherein determining the one or more geographical location attributes that are related to the user's selection of the hyperlink comprises determining at least one of the one or more geographical location attributes to be a particular geographical region that is mapped to a portal web page through which the search engine received the query.

16. The volatile or non-volatile computer-readable storage medium of claim 11, wherein determining the one or more geographical location attributes that are related to the user's selection of the hyperlink comprises determining at least one of the one or more geographical location attributes to be a particular geographical region that is mapped to a group of Internet Protocol (IP) addresses that contains a particular IP address of a device from which the search engine received the query.

17. The volatile or non-volatile computer-readable storage medium of claim 11, wherein determining the geographical region for the resource to which the hyperlink refers comprises determining one or more features of a distribution that indicates, for each particular region in a set of regions, a quantity of selections of the hyperlink that were associated with that particular region.

18. The volatile or non-volatile computer-readable storage medium of claim 17, wherein determining the one or more features of the distribution comprises determining a minimum number of regions in the distribution that cover a specified proportion of a total number of hyperlink selections represented by the distribution, wherein determining the one or more features of the distribution comprises determining the distribution's entropy, and wherein the steps further comprise:
selecting, based on the one or more features of the distribution, and from among multiple distribution feature sets that a machine-learning mechanism has automatically mapped to different geographical regions, a particular distribution feature set that has one or more features in common with the one or more features of the distribution;
wherein determining the geographical region for the resource to which the hyperlink refers comprises determining the geographical region for the resource to which the hyperlink refers to be a particular geographical region to which the machine-learning mechanism automatically mapped the particular feature distribution set.

19. The volatile or non-volatile computer-readable storage medium of claim 17, wherein the resource is a first resource, wherein determining the one or more features of the distribution comprises determining a first distribution for the first resource, and further comprising:
determining a second distribution for a second resource that differs from the first resource;
normalizing the first distribution with the second distribution by performing smoothing on the first distribution and the second distribution; and
wherein determining the geographical region for the first resource comprises determining the geographical region for the first resource based at least in part on a version of the first distribution on which said smoothing has been performed.

20. A volatile or non-volatile computer-readable storage medium storing one or more instructions which, when executed by one or more processors, cause the one or more processors to perform the method recited in claim 10.
